(19) United States
(12) Patent Application Publication
(10) Pub. No.: US 2022/0026572 A1
(43) Pub. Date: Jan. 27, 2022

(54) FAN BLADE SURFACE PROFILE CURVE FITTING METHOD, SYSTEM, DEVICE, AND STORAGE MEDIUM

(71) Applicant: Shanghai Clobotics Technology Co., Ltd., Shanghai (CN)

(72) Inventors: Haonan Dai, Shanghai (CN); Xun Liu, Shanghai (CN); Hang Su, Shanghai (CN)

(21) Appl. No.: 17/333,322

(22) Filed: May 28, 2021

(30) Foreign Application Priority Data
Jul. 21, 2020 (CN) 2020107077669

(51) Int. Cl. G01S 17/89; G01B 11/30; B64F 5/60

(52) U.S. Cl. CPC G01S 17/89; B64F 5/60; G01B 11/30

(57) ABSTRACT

The present disclosure relates to the technical field of point cloud curve fitting, and in particular, to a fan blade surface profile curve fitting method, system, device, and storage medium. According to the fan blade surface profile curve fitting method, system, device, and storage medium provided by the present disclosure, each frame of obtained point cloud data is fit multiple times to obtain fitting curves, then an average curve based on the point cloud data is obtained by using the fitting curves, and finally a projection of the average curve onto a projection plane is obtained by using the projection plane constructed in each frame of point cloud data, apparently, the projection of the average curve described here is a fan blade surface profile curve proposed by the present disclosure.

### FIELD OF THE INVENTION

The present disclosure relates to the technical field of point cloud curve fitting, and in particular, to a fan blade surface profile curve fitting method, system, device, and storage medium.

### BACKGROUND

Wind-driven generators are power devices that convert wind energy into mechanical work which drives a rotor to rotate, and finally output alternating currents. Main components of the wind-driven generator are blades extending several meters long. The rotation of the blades drives a motor inside the wind-driven generator to rotate, and finally the wind energy is converted into electrical energy for output. The normal operation of the blades is the key for the wind-driven generator to stably and effectively output the electrical energy. Therefore, the “normal” blades are crucial for the wind-driven generator.

In order to ensure that the blades are always in the best condition, blade inspection has become routine work during operation of the wind-driven generator and its supporting equipment. Especially with the rapid development of artificial intelligence technologies, a blade inspection manner using an unmanned aerial vehicle (UAV) has been used more and more widely.

### SUMMARY OF THE INVENTION

In an aspect of the present disclosure, a fan blade surface profile curve fitting method is provided. The method includes the following steps:

obtaining point cloud data respectively corresponding to each blade surface of a fan blade;

in each of the point cloud data, fitting each frame of point cloud data multiple times to obtain a plurality of point cloud fitting curves that are distributed in columns in each frame of point cloud data;

averaging the plurality of fitting curves in each frame of point cloud data to obtain an average curve formed by average value points in each frame of point cloud data;

constructing one projection plane perpendicular to a length direction of the blade in each frame of point cloud data; and

respectively projecting the average value points onto a projection plane in a corresponding frame of point cloud data to obtain a profile curve that fits the blade surface.

In one embodiment, the step of obtaining point cloud data respectively corresponding to each blade surface of a fan blade includes:

scanning the blade along a flight trajectory covering each blade surface of the fan blade by using a LIDAR carried by an unmanned aerial vehicle (UAV); and

generating one piece of point cloud data corresponding to one blade surface of the fan blade after the blade surface is scanned until the point cloud data of each blade surface is obtained.

In one embodiment, the step of fitting each frame of point cloud data multiple times in each point cloud data to obtain a plurality of point cloud fitting curves that are distributed in columns in each frame of point cloud data includes:

obtaining a resolution of each frame of point cloud data in each point cloud data; and

fitting each frame of point cloud data by taking a row count of the resolution as the number of fitting to obtain the point cloud fitting curves that are distributed in columns and have the same number as the number of fitting.

In one embodiment, the number of fitting is 20.

In one embodiment, the step of averaging the plurality of fitting curves in each frame of point cloud data to obtain an average curve formed by average value points in each frame of point cloud data includes:

obtaining an arrangement order of each point on each of the fitting curves according to the same order direction; and

calculating an average value of points having the same arrangement order in the fitting curves to obtain the average curve formed by the average value points.

In one embodiment, the step of constructing one projection plane and the step of projecting the average curve onto a projection plane in a corresponding frame of point cloud data are both performed in a coordinate system of the blade.

In one embodiment, in each of the point cloud data, an interval between two adjacent projection planes is an interval between central points of two frames of point cloud data where the projection planes are located.

In another aspect of the present disclosure, a fan blade surface profile curve fitting system is provided. The fan blade surface profile curve fitting system is configured to implement the steps of the previously described fan blade surface profile curve fitting method. The fan blade surface profile curve fitting system includes:

a data acquisition module, configured to obtain point cloud data respectively corresponding to each blade surface of a fan blade;

a curve fitting module, configured to fit each frame of point cloud data multiple times in each of the point cloud data to obtain a plurality of point cloud fitting curves that are distributed in columns in each frame of point cloud data;

a data calculation module, configured to average the plurality of fitting curves in each frame of point cloud data to obtain an average curve formed by average value points in each frame of point cloud data; and

a point cloud projection module, configured to construct one projection plane perpendicular to a length direction of the blade in each frame of point cloud data; and

further configured to respectively project the average value points onto a projection plane in a corresponding frame of point cloud data to obtain a profile curve that fits the blade surface.

In still another aspect of the present disclosure, a fan blade surface profile curve fitting device is provided. The fan blade surface profile curve fitting device includes:

a memory, configured to store computer programs; and

a processor, configured to execute the computer programs so as to implement the steps of the fan blade surface profile curve fitting method according to the previous aspect of the present disclosure.

In the last aspect of the present disclosure, a computer-readable storage medium is provided. The computer-readable storage medium stores computer programs that, when executed by a processor, implement the steps of the previously described fan blade surface profile curve fitting method.

According to the fan blade surface profile curve fitting method, system, device, and storage medium provided by the present disclosure, each frame of obtained point cloud data is fit multiple times to obtain fitting curves, then an average curve based on the point cloud data is obtained by using the fitting curves, and finally a projection of the average curve onto a projection plane is obtained by using the projection plane constructed in each frame of point cloud data, apparently, the projection of the average curve described here is a fan blade surface profile curve proposed by the present disclosure.

### BRIEF DESCRIPTION OF THE DRAWINGS

The drawings exemplarily illustrate embodiments and constitute one part of the description, and are used to explain exemplary implementations of the embodiments in conjunction with text descriptions of the description. The illustrated embodiments are merely for the purpose of example, but not intended to limit the scope of the claims. Throughout the drawings, same reference signs refer to similar but not necessarily the same elements.

FIG. 1 is schematic diagram of a fan blade surface profile curve of the present disclosure;

FIG. 2 is a flowchart of steps of a fan blade surface profile curve fitting method provided by one embodiment of the present disclosure;

FIG. 3 is a schematic diagram of a module connection of a fan blade surface profile curve fitting system provided by one embodiment of the present disclosure;

FIG. 4 is a schematic structural diagram of a fan blade surface profile curve fitting device provided by one embodiment of the present disclosure; and

FIG. 5 is a schematic structural diagram of a computer-readable storage medium provided by one embodiment of the present disclosure.

### DETAILED DESCRIPTION OF THE EMBODIMENTS

From the above description, it can be seen that blades are important components of a wind-driven generator, and the “normal” blades are crucial for the wind-driven generator.

In order to ensure that the blades are always in the best condition, blade inspection has become routine work during operation of the wind-driven generator and its supporting equipment.

A conventional blade inspection manner is to use manual remote observation on the ground on the blades. For a higher fan or a fan having a longer blade, a device such as a telescope is further provided to assist in inspection. Apparently, due to a distance limitation, it is difficult to find a fine damage on the blade by using the conventional artificial inspection manner. Therefore, in practical work, the manual inspection manner also troubles operators and manufacturers in the wind power industry.

With the development of artificial intelligence technologies, a blade inspection manner using an unmanned aerial vehicle (UAV) has gradually entered people's vision. The fan blade inspection manner using the UAV is that specifically, a UAN carrying a shooting device flies to the height of the fan blade, and then flies according to a predetermined flight path, photos are continually taken for the blades during the flight, and finally defect analysis is performed on blade images on the taken photos.

Apparently, a desired result cannot be obtained through manual analysis for the obtained images (the performance and efficiency of the artificial processing cannot cope with a challenge posed by a huge number of images). However, the use of computers in conjunction with image processing is also prone to serious errors in a calculated damage size (generally refers to a length, width and/or area of a damage) due to the inability to obtain an accurate fan blade surface profile curve.

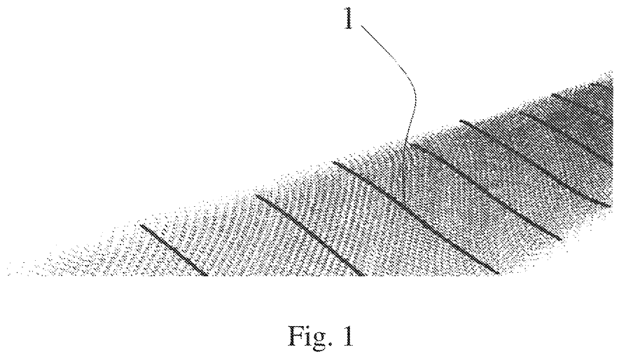

A fan blade surface profile curve provided by the present disclosure may refer to a profile curve 1 in FIG. 1. It is a line that fits one surface of a fan blade (according to a requirement of the UAV to obtain the overall fan blade, generally a surface of a fan blade is divided into multiple areas, for example, the fan blade may be divided into a front blade surface, a rear blade surface, a lower blade surface (a surface viewed from a low angle when the blade is in a horizontal state), and a upper blade surface (a surface viewed from a high angle when the blade is in a horizontal state)), and forms an angle with a length direction of the blade. According to a method provided by the present disclosure, a profile curve corresponding to (fitting) one surface of the fan blade. But this also readily inspires a person skilled in the art to extend the profile curve to a profile curve surrounding the fan blade (e.g. a surrounding profile curve perpendicular to the length direction of the blade).

In order to solve the problems existing in the prior art, and improve the accuracy of an obtained fan blade surface profile curve, the inventor proposes a fan blade surface profile curve fitting method through creative efforts. An accurate profile curve the fits a fan blade surface can be obtained by using the method, laying a favorable foundation for a subsequent calculation of a damage size of the blade surface.

A fan blade surface profile curve fitting method, system, device, and storage medium provided by the present disclosure will be further described in detail with reference to the drawings and specific embodiments. Advantages and features of the present disclosure will be clearer through the claims and the following descriptions. It should be noted that the drawings in a very simplified form and imprecise proportions are merely used to conveniently and clearly assist in explaining the embodiments of the present disclosure.

It can be understood that the terms in the description are used to describe specific embodiments, but not intended to limit the present disclosure. Unless otherwise defined, all terms (including technical terms and scientific terms) used in the description have the same meanings generally understood by those skilled in the art. For concision and/or clearness, commonly known functions or structures will not explained in detail.

### Example Illustration of the Fan Blade Surface Profile Curve Fitting Method

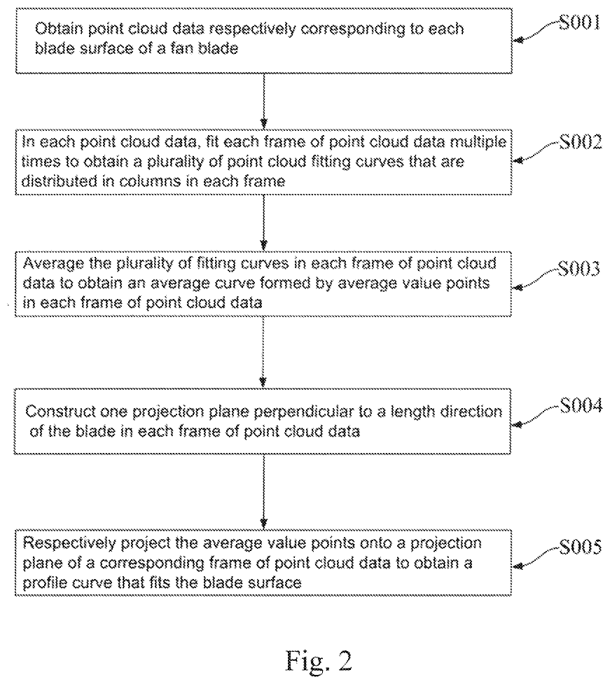

Referring to FIG. 2, a flowchart of steps of a fan blade surface profile curve fitting method provided by one embodiment of the present disclosure is shown.

At S001 of the present embodiment, point cloud data respectively corresponding to each blade surface of a fan blade is obtained.

Because fan blades are mostly in high altitude, it is very difficult to obtain point cloud data artificially, in implementation, the fan blade may be scanned by using the UAV carrying a LIDAR such as a CE30 model according to a predetermined flight path, and then the point cloud data of each blade surface of the fan blade is obtained.

According to the description in the present disclosure, one fan blade is divided into a plurality of surfaces. This is because the surfaces of the fan blade are curved and the LIDAR cannot obtain all the surfaces covering the fan blade at one time. In order to obtain all the surfaces covering the fan blade, it is necessary to divide the fan blade surface into a plurality of parts (e.g. according to the division manner illustrated in the present disclosure), and respectively scan each surface, so as to obtain the point cloud data of all the surfaces of the fan blade.

At S002 of the present embodiment, in each of the point cloud data, each frame of point cloud data is fit multiple times to obtain a plurality of point cloud fitting curves that are distributed in columns in each frame of point cloud data;

apparently, one curve can be obtained for each fitting. However, the fitting at S002 is not conventional simple fitting, but a large number of fitting curves that are distributed in columns are finally obtained. The distribution in columns here refers to that the plurality of curves are spaced apart from each other and distributed in columns side by side. It should be noted that the shorter the fitting line segment, the lager the angle between the line segment and the length direction of the blade, and more structure information of the blade surface can be presented. Certainly, a series of points can be fitted by using the prior art to obtain a curve that satisfies predetermined arrangement and an orientation requirements, thus a single curve in S002 can be obtained by using existing methods. However unlike the existing methods, the fitting needs to be performed multiple times according to a width direction of a point cloud frame at S002, for example, if the LIDAR is a CE30 model and has a resolution of 320*20 (column count*row count), according to the present disclosure, 20 rows of points are fitted to obtain 20 fitting curves that are distributed in columns (along columns in each frame of point data data). When a point cloud emitted by the LIDAR is projected onto the fan blade, a length direction of a point cloud frame forms an angle with the length direction of the blade, so the fitting curve is actually a line segment in each row of point data on the point cloud frame. It is easy to understand that a desired angle between the length direction of the point cloud frame and the length direction of the blade is 90°, but generally is not strictly required to be 90°. The fitting solution is conducive to more accurately reflecting a change of the point data of the fan blade surface, and is conducive to finally obtaining a profile curve that better fits the fan bladed surface compared to the manner of only obtaining one fitting curve.

The number of fitting may further be adjusted reasonably in other embodiments of the present disclosure, and the specific number of fitting may be consistent with the row count of the resolution of the LIDAR, so as to easily obtain more smooth and accurate fitting curves.

At S003, the plurality of fitting curves in each frame of point cloud data are averaged to obtain an average curve formed by average value points in each frame of point cloud data;

in the present embodiment, the plurality of fitting curves are averaged to finally obtain the average value points, certainly the average value points form one average curve visually. An essence of S003 is to identify a curve that is more closely conforms to a change of the blade surface profile from each frame of point cloud data. In present embodiment, the curve is obtained by averaging the fitting curves. The average curve obtained through the manner can comprehensively reflect characteristics of each fitting curve, and greatly reduce the calculated amount so as to fast obtain a desired curve.

It will be readily appreciated that, through the operation of Bessel curve fitting, it is possible to obtain the same number of points at equal intervals that are used to form the curves, and it is only necessary to average the points on each curve to obtain the average value points. Therefore, the manner for obtaining of the average curve may be selected reasonably in other embodiments. Unlike a conventional manner for calculating an average curve (average value points), in order to prevent confusion and improve the accuracy of the average curve, an order direction is specially defined in other embodiments of the present disclosure, that is, for each fitting curve, an arrangement order (may be referred to as a number) of each point in each fitting curve is determined in sequence according to the same order direction. When the average curve is calculated, only an average value of the points with the same arrangement order on each fitting curve is calculated. The calculated average value will essentially appear as a point in a corresponding frame of point cloud data, which is defined as an average value point in the present disclosure. When the points with each arrangement order in one frame of point cloud data are calculated to obtain the average values, a series of average value points will appear in the frame of point cloud data, and the series of average value points are arranged according to one direction to form one curve, which is the required average curve.

In order to further improve the accuracy of the finally obtained profile curve, in the present disclosure, the average curve is projected, that is, at S004, one projection plane perpendicular to the length direction of the blade is constructed in each frame of point cloud data.

According to the teachings of the present disclosure, an interval between projection planes in two adjacent frames of point cloud data may further be defined in other embodiments, so as to set the projection planes more conveniently, For example, an interval between two adjacent projection planes is defined as an interval between central points of two adjacent frames of point cloud data.

In order to more conveniently set the projection plane, a central point of a frame of point cloud data where the projection is located may further be directly set.

In addition, at S005, the average curve (the average value points) is respectively projected onto a projection plane in a corresponding frame of point cloud data (i.e. an average curve in one frame of point cloud data is projected to a projection plane in the frame of point cloud data) to finally obtain a profile curve that fits the blade surface.

The fan blade is scanned by using a device such as LIDAR to obtain the point cloud data, and the point cloud data is generally represented by a world coordinate system or a coordinate system inside a LIDAR system, which is very unfavorable for a subsequent projection calculation. Therefore, before the projection, the obtained curve may be converted into a coordinate system of the blade with a blade root of the blade as a origin and the length direction of the blade as an x-axis (a y-axis and a z-axis may be set reasonably according to actual needs) to reduce the calculated amount and improve the efficiency of obtaining of the profile curve that fits the fan blade surface.

According to the above steps, in the present disclosure, each frame of the obtained point cloud data is fit multiple times to obtain the fitting curves, then the average curve based on the point cloud data is obtained by using the fitting curves, and finally the projection of the average curve onto the projection plane is obtained by using the projection plane constructed in each frame of point cloud data, apparently, the projection of the average curve described here is a fan blade surface profile curve proposed by the present disclosure.

The curve obtained by the above method may accurately fit the fan blade surface, and a combination of the curves can present a structural shape of the fan blade. Certainly, because the curves accurately fit the fan blade, the structural shape of the fan blade presented by the combination formed according to position relationships in the coordinate system may also be enough accurate. Therefore, the present disclosure defines that the curve fits the blade surface.

### Example Illustration of a Fan Blade Surface Profile Curve Fitting System

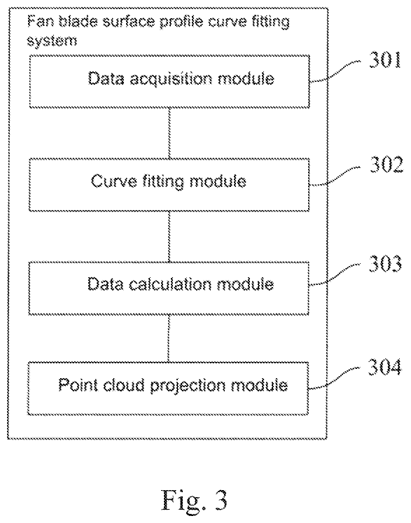

One embodiment of the present disclosure further provides a fan blade surface profile curve fitting system. In FIG. 3, a schematic diagram of a module connection of a fan blade surface profile curve fitting system provided by one embodiment of the present disclosure is illustrated. The system can implement the fan blade surface profile curve fitting method described in the present disclosure. In order to implement the fan blade surface profile curve fitting method described in the present disclosure, the system includes:

a data acquisition module 301, configured to obtain point cloud data respectively corresponding to each blade surface of a fan blade;

a curve fitting module, configured to fit each frame of point cloud data multiple times in each of the point cloud data to obtain a plurality of point cloud fitting curves that are distributed in columns in each frame of point cloud data;

a data calculation module, configured to average the plurality of fitting curves in each frame of point cloud data to obtain an average curve formed by average value points in each frame of point cloud data; and

a point cloud projection module, configured to construct one projection plane perpendicular to a length direction of the blade in each frame of point cloud data; and

further configured to respectively project the average value points onto a projection plane in a corresponding frame of point cloud data to obtain a profile curve that fits the blade surface.

### Example Illustration of a Fan Blade Surface Profile Curve Fitting Device

One embodiment of the present disclosure further provides a fan blade surface profile curve fitting device. The fitting device includes:

a memory, configured to store computer programs; and

a processor, configured to execute the computer programs so as to implement the steps of the fan blade surface profile curve fitting method described in the present disclosure.

Each aspect of the present disclosure may be implemented into a system, method or program product. Therefore, each aspect of the present disclosure may be specifically implemented into the following forms, i.e. a complete hardware implementation, a complete software implementation (including firmware, micro codes, etc.), or a combination implementation of hardware and software, which may be collectively referred to as “circuits”, “modules” or “platforms” here.

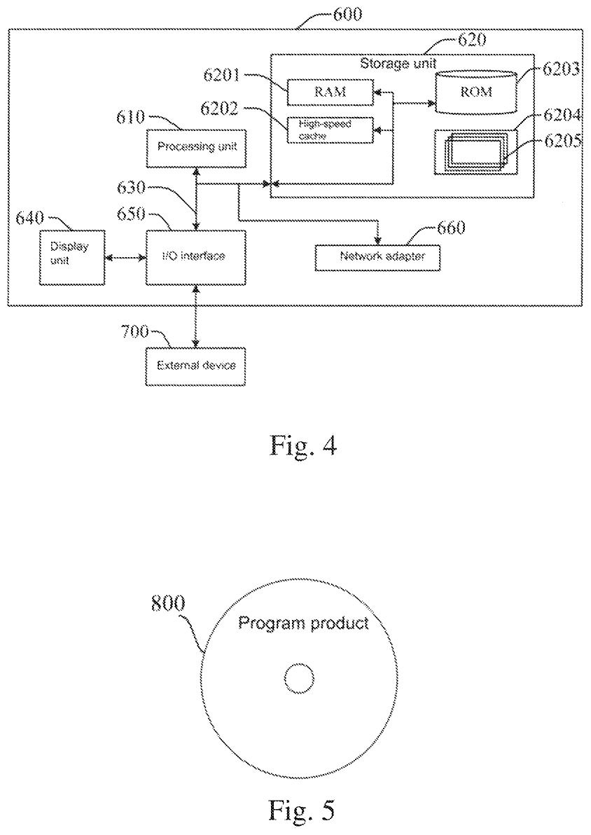

FIG. 4 is a schematic structural diagram of a fan blade surface profile curve fitting device provided by one embodiment of the present disclosure. An electronic device 600 implemented according to an implementation of the present embodiment will be described below in detail with reference to FIG. 4. The electronic device 600 shown in FIG. 4 is only an example, but not intended to limit functions and the scope of use of any embodiment of the present disclosure.

As shown in FIG. 4, the electronic device 600 is represented in the form of a general-purpose computing device. Components of the electronic device 600 may include but are not limited to: at least one processing unit 610, at least one storage unit 620, a bus 630 connected with different platform components (including the storage unit 620 and the processing unit 610), a display unit 640, etc.

Wherein the storage unit stores program codes that, when executed by the processing unit 610, enable the processing unit 610 to perform the steps of the implementations of the present embodiment described in the part of the profile curve fitting method of the present disclosure. For example, the processor 610 may perform the steps shown in FIG. 2.

The storage unit 620 may include a readable medium in the form of a volatile storage unit, such as a random access memory (RAM) and/or a high-speed cache storage unit, and may further include a read-only memory (ROM) 6203.

The storage unit 620 may further include a group of (at least one) program modules 6205/utilities 6204, the program modules 6205 include but are not limited to: an operation system, one or more application programs, other program modules and program data, and each or a certain combination of the examples may include an implementation of a network environment.

The bus 603 may represent one or more of multiple types of bus structures, and includes a storage unit bus or a storage unit controller, a peripheral bus, an image acceleration port, a processing unit, or a local bus using any one of a plurality of bus structures.

The electronic device 600 may also communicate with one or more external devices 700 (e.g. a key board, a pointing device, a Blue-tooth device), and may further communicate with one or more devices that enable a user to interact with the electronic device 600, and/or any device (e.g. a router, a modem) that enables the electronic device 600 to communicate with one or more other computing devices. The communication may be performed via an input/output (I/O) interface 650. Moreover, the electronic device 600 may further communicate with one or more networks (e.g. a local area network (LAN), a wide area network (WAN), and/or a public network such as Internet) through a network adapter 660. The network adapter 660 may communicate with other modules of the electronic device 600 via the bus 630. It should be understood that although not show in FIG. 4, other hardware and/or software modules that may be used in conjunction with the electronic device 600, includes but are not limited to: a micro code, a device driver, a redundant processing unit, an external disk drive array, a RAID system, a tapes driver, a data backup storage platform, etc.

### Example Illustration of a Readable Storage Medium

One embodiment of the present disclosure further provides a computer-readable storage medium storing computer programs that, when executed by a processor, implement the steps of the above disclosed fan blade surface profile curve fitting method. Although other specific implementations are not exhaustively listed in the present embodiment, in some possible implementations, various aspects described in the present disclosure may further be implemented into the form of a program product including program codes that, when run on a terminal device, are used to enable the terminal device to perform the steps of the implementations of various embodiments of the present disclosure described in the part of the fitting method of the present disclosure.

FIG. 5 is a schematic structural diagram of a computer-readable storage medium provided by one embodiment of the present disclosure. As shown in FIG. 5, a program product 800 configured to implement the above method according to the implementations of the present disclosure is illustrated, and may be a portable compact disk read-only memory (CD-ROM) including program codes, and run on a terminal device such as a personal computer. However, the program product of the present disclosure is not limited to that, in the present disclosure, the readable storage medium may be any tangible medium that includes or stores programs that can be used by or used together with an instruction execution system, apparatus or device.

The program product may adopt one or any combination of more readable media. The readable media may be a readable signal medium or readable storage medium. The readable storage medium may be but is not limited to, for example, an electronic, magnetic, optical, electromagnetic, infrared, or semi-conductor system, apparatus or device, or any combination of the above media. More specific examples (a non-exhaustive list) of the readable medium includes: an electric connection having one or more wires, a portable disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above media.

The computer-readable storage medium may include a data signal in a base band or propagated as one part of a carrier wave, and carries a readable program code. The propagated data signal may be in a plurality of forms, include but are not limited to an electromagnetic signal, an optical signal, or any combination of the above signals. The readable storage medium may further be any readable medium other than the readable storage medium, and the readable medium can transmit, propagate or transfer programs used by or used together with an instruction execution system, apparatus or device. The program code included in the readable storage medium can be transferred by any suitable medium that includes but is not limited to wireless, wired, optical cable, RF, etc., or any suitable combination of the above media.

One or any combination of more programming languages can be used to write the program code used for performing the operations of the present disclosure, and the programming languages include object-oriented programming languages such as Java and C++, and further include conventional procedural programming languages such as C language or similar programming languages. The program code may be completely executed on a computing device of a user, partially executed on device of the user, executed as an independent software package, partially executed on the computing device of the user and partially executed on a remote computing device, or completely executed on the remote computing device or a server. When the remote computing device is involved, the remote computing device may be connected to the computing device of the user via any type of network, including a local area network (LAN) or wide area network (WAN), or may be connected to an external computing device (e.g. connected via Internet provided by a Internet service provider).

In conclusion, according to the fan blade surface profile curve fitting method, system, device, and storage medium provide by the present disclosure, each frame of obtained point cloud data is fit multiple time to obtain fitting curves, then an average curve based on the point cloud data is obtained by using the fitting curves, and finally a projection of the average curve onto a projection plane is obtained by using the projection plane constructed in each frame of point cloud data, apparently, the projection of the average curve described here is a fan blade surface profile curve described in the present disclosure.

The above description is only a description of the preferred embodiments of the present disclosure, and is not intended to limit the scope of the present disclosure in any way. Any change or modification made by those of ordinary skill in the art of the present disclosure based on the above disclosure shall all fall within the scope of protection of the claims.

1. A fan blade surface profile curve fitting method, characterized by comprising the following steps:
obtaining point cloud data respectively corresponding to each blade surface of a fan blade;
in each of the point cloud data, fitting each frame of point cloud data multiple times to obtain a plurality of point cloud fitting curves that are distributed in columns in each frame of point cloud data;
averaging the plurality of fitting curves in each frame of point cloud data to obtain an average curve formed by average value points in each frame of point cloud data;
constructing one projection plane perpendicular to a length direction of the blade in each frame of point cloud data; and
respectively projecting the average value points onto a projection plane in a corresponding frame of point cloud data to obtain a profile curve that fits the blade surface.

2. The fan blade surface profile curve fitting method according to claim 1, characterized in that the step of obtaining point cloud data respectively corresponding to each blade surface of a fan blade comprises:
scanning the blade along a flight trajectory covering each blade surface of the fan blade by using a LIDAR carried by an unmanned aerial vehicle (UAV); and
generating one piece of point cloud data corresponding to one blade surface after the blade surface is scanned until the point cloud data of each blade surface is obtained.

3. The fan blade surface profile curve fitting method according to claim 1, characterized in that the step of in each point cloud data, fitting each frame of point cloud data to obtain a plurality of point cloud fitting curves that are distributed in columns in each frame of point cloud data comprises:
obtaining a resolution of each frame of point cloud data in each point cloud data; and
fitting each frame of point cloud data by taking a row count of the resolution as the number of fitting to obtain the point cloud fitting curves that are distributed in columns and have the same number as the number of fitting.

4. The fan blade surface profile curve fitting method according to claim 3, characterized in that the number of fitting is 20.

5. The fan blade surface profile curve fitting method according to claim 1, characterized in that the step of averaging the plurality of fitting curves in each frame of point cloud data to obtain an average curve formed by average value points in each frame of point cloud data comprises:
obtaining an arrangement order of each point on each of the fitting curves according to the same order direction; and
calculating an average value of points having the same arrangement order in the fitting curves to obtain the average curve formed by the average value points.

6. The fan blade surface profile curve fitting method according to claim 1, characterized in that the step of constructing one projection plane and the step of projecting the average curve onto a projection plane in a corresponding frame of point cloud data are both performed in a coordinate system of the blade.

7. The fan blade surface profile curve fitting method according to claim 1, characterized in that in each of the point cloud data, an interval between two adjacent projection planes is an interval between central points of two frames of point cloud data where the projection planes are located.

8. A fan blade surface profile curve fitting system configured to implement the steps of the fan blade surface profile curve fitting method according to claim 1, characterized by comprising:
a data acquisition module, configured to obtain point cloud data respectively corresponding to each blade surface of a fan blade;
a curve fitting module, configured to fit each frame of point cloud data multiple times in each of the point cloud data to obtain a plurality of point cloud fitting curves that are distributed in columns in each frame of point cloud data;
a data calculation module, configured to average the plurality of fitting curves in each frame of point cloud data to obtain an average curve formed by average value points in each frame of point cloud data; and
a point cloud projection module, configured to construct a projection plane perpendicular to a length direction of the blade in each frame of point cloud data; and
further configured to respectively project the average value points onto a projection plane in a corresponding frame of point cloud data to obtain a profile curve that fits the blade surface.

9. A fan blade surface profile curve fitting device, characterized by comprising:
a memory, configured to store computer programs; and
a processor, configured to execute the computer programs so as to implement the steps of the fan blade surface profile curve fitting method according to claim 1.

10. A computer-readable storage medium, characterized by storing computer programs that, when executed by a processor, implement the steps of the fan blade surface profile curve fitting method according to claim 1.
